(19) United States
(12) Patent Application Publication
(10) Pub. No.: US 2006/0122543 A1
(43) Pub. Date: Jun. 8, 2006

(54) Method for promoting tissue regeneration on wound surfaces as device and treatment instrument or implant for carrying out method

(75) Inventors: Jorg Mayer, Niederlenz (CH); Christopher Rast, Biel (CH); Marcel Aeschlimann, Ligerz (CH); Laurent Torriani, Lamboing (CH)

Correspondence Address: RANKIN, HILL, PORTER & CLARK LLP, 4080 ERIE STREET, WILLOUGHBY, OH, 44094-7836, US

(73) Assignee: WOODWELDING AG, Zurich (CH)

(21) Appl. No.: 10/528,867

(22) PCT Filed: Jul. 29, 2004
(86) PCT No.: PCT/CH04/00474

§ 371 Date: Apr. 25, 2005

(30) Foreign Application Priority Data
Jul. 31, 2003 (CH) 1338/03

(51) Int. Cl. A61H 7/00

(52) U.S. Cl. 601/10

(57) ABSTRACT

For promoting tissue regeneration on wound surfaces (1) mechanical oscillation is coupled into the wound surfaces. A treatment instrument (2) coupled to an oscillation drive is brought into contact with the wound surface (1), or an implant is impinged with oscillation during and/or after being positioned in the tissue. The oscillation acts mechanically and thermally on the tissue in the region of the treated wound surface (1), and according to the intensity acts in a stimulating, traumatic, necrotic or cell-destroying manner. Therefore, biological elements inhibiting tissue regeneration are destroyed or denatured and the metabolism in the region of the wound surface is stimulated. The effect may also be a mechanical one, slightly compacting or regionally dislocating the tissue. Since the treatment can be effected during or after positioning an implant, necrosis in particular effects undesired cells, such as connective tissue cells, mucous cells and diseased cells having been brought to the wound surface with the implant, which cells may inhibit the intergrowth between tissue and implant.

### BACKGROUND OF THE INVENTION

1. Field of the Invention

The invention lies in the field of medical technology. The method serves for promoting tissue regeneration on surfaces of wounds caused by surgery, injury or disease, which wound surfaces are to intergrow with other wound surfaces or with an implant, or are to heal into tissue surfaces (natural tissue surfaces or scars) by way of tissue regeneration. The method serves in particular for the treatment of such wound surfaces in bone tissue. The invention further relates to a device and a treatment instrument or implant according to the preambles of the corresponding, independent claims, device and instrument or implant all serving for carrying out the method.

2. Description of the Related Art

According to the state of the art the mentioned wound surfaces caused by surgical operation, injury or disease are treated by way of curettage or avivement, that is to say they are mechanically scraped or scratched, by which means the tissue layers lying directly on the wound surface are removed in order to get a fresh wound surface. Additionally to the mentioned, mechanical treatment or independently of this, such wound surfaces are treated chemically also, by which treatment cells or other undesired biological elements in the region of the wound surface are destroyed or denatured. The aim of the mentioned treatments is to produce wound surfaces which are as fresh as possible and which are free of undesired biological elements (germs causing disease, tissue-foreign cells, diseased cells such as tumour cells after removal of a tumour) which may negatively influence the desired tissue regeneration. A further aim of the treatments is to encourage metabolism in the region of the wound surface and thus to positively influence tissue regeneration.

The above cited, mechanical treatment methods are carried out with scraping or scratching instruments (curettes) and for this reason are quite difficult to be adapted for minimal-invasive (endoscopic) surgery. For implantations a further problem concerns the fact that the treatment of the wound surface which is to intergrow with the implant, needs to be carried out before the implant is positioned and that for this reason the treatment is ineffective against undesired cells, such as connective tissue cells and mucous cells which have been carried with the implant onto the wound surface. Such cells often lead to a layer of connective tissue between the implant and the tissue surrounding the implant which layer delays or even prevents a desired, stable intergrowth between the implant and the tissue.

The publication U.S. Pat. No. 6,139,320 (Hahn) describes a method of the dental field which method serves for the abrasive treatment of surfaces of teeth to be restored or of bone surfaces surrounding a tooth. For this abrasive treatment a slurry of abrasive particles and an instrument excited by ultrasonic oscillation are used, wherein the instrument brings the slurry into a high turbulence in a manner such that the dentine or bone tissue is removed by way of cavitation. During the operation the slurry is continuously rinsed around the instrument, which means that the slurry is also used to transport away removed material. For the treatment, the instrument must be positioned in a manner such that there is always a slurry film between the surface to be treated and the instrument. There is no cavitation effect if there is no distance between the instrument and the material to be removed (no slurry film), and neither if this distance is too large.

The device used for the abrasive treatment according to U.S. Pat. No. 6,139,320 comprises an electromechanical transducer or oscillation drive (produces mechanical oscillation from electrical oscillation, for example using piezoelements). A deflection element is coupled to the oscillation drive, as the case may be via a booster (amplifier), and this element deflects the axial oscillations of the oscillation drive by for example 90° or 120°. The instrument used for the abrasive treatment is coupled to the deflection element in a manner such that it extends in the direction of the deflected oscillations and therefore oscillates in the direction of its axis.

In order to adapt a tooth opening to be created or to be finished by the proposed abrasive treatment to a filling element to be positioned in the opening, U.S. Pat. No. 6,139,320 suggests to use the filling element directly as an ultrasonic instrument. Since a fluid film between the instrument and the surface to be treated is necessary for the abrasive treatment (see above), the opening created with the help of the filling element cannot represent a tight seat for the filling element. This means that the filling element must finally be fastened into the opening e.g. with cement, in which case the cement cannot be applied until after the opening has been created.

### SUMMARY OF THE INVENTION

It is the object of the invention to create a method for promoting tissue regeneration on wound surfaces, wherein the wound surfaces, by way of tissue regeneration, are for example to grow together with other wound surfaces or with an implant, or are to heal into tissue surfaces. At the same time the method according to the invention is to be easily applicable for minimal-invasive surgery. The results achieved by the method according to the invention are to be at least as good as the results achieved with known methods serving the same purpose. Furthermore, the method is to permit to solve the above-discussed problem of the undesired cells carried onto wound surfaces by implants. It is a further object of the invention to provide a device for carrying out the method, as well as a treatment instrument or implant for carrying out the method.

The mentioned objects are achieved by the method, the device and the treatment instrument or implant as defined in the claims.

The method according to the invention is based on the discovery that by way of mechanical oscillation, for example ultrasonic oscillation, being coupled into a wound surface to be treated, a mechanical and thermal effect is achieved which effect is well controllable with regard to intensity, depth and locality. Depending on the intensity and on the kind of tissue in the wound surface, the named effect produces a controlled trauma or a targeted necrosis or cell destruction. By way of irritation and trauma the metabolism is stimulated and by way of trauma, necrosis or cell destruction, undesirable biological elements are destroyed or denatured. Both mentioned effects are known to promote tissue regeneration. In addition the tissue in the region of the treated wound surface, in particular bone tissue may be mechanically modified by the mechanical effect of the oscillation, for example may be slightly compacted, or may be slightly dislocated, which likewise appears to positively influence tissue regeneration.

According to the invention, mechanical oscillation, in particular ultrasonic oscillation is coupled into the wound surface to be treated and by way of this the tissue of the region of the wound surface is vibrated (mechanical effect) and a thermal effect is achieved by damping of the oscillation in the tissue. As the method can be adapted very accurately to given conditions, thus destroying only a necessary minimum of tissue in the process, the removal of material from the treatment area during or after treatment is not needed in the method according to the invention.

Either a treatment instrument or an implant serves for coupling the oscillation into the wound surface, wherein the instrument or implant is designed as an oscillation body being actively connected to an oscillation drive, possibly via a further oscillation body. The individual elements of the oscillation system are advantageously matched to one another and to the excitation frequency in a manner such that they oscillate in resonance. A device for carrying out the method according to the invention comprises an oscillation drive and, as the case may be, one or more oscillation bodies coupled to the oscillation drive, wherein the treatment instrument or implant is coupled or is couplable to the oscillation drive or to one of the oscillation bodies. The coupling for a treatment instrument is a fixed or releasable connection. For an implant the coupling is realised by a releasable connection or by simply placing the device onto a coupling surface of the implant.

For the treatment, an instrument is brought into contact with the wound surface to be treated, i.e. it is pressed against the surface as well as oscillated. The implant is positioned in the tissue and is then pressed against the tissue and oscillated, or it is advantageously positioned while already oscillating (e.g. into a tissue opening which is slightly smaller than the instrument or implant, or as a self-cutting implant without a previously created tissue opening, or into a tissue opening which is at least in parts considerably smaller than the implant). The contact between the instrument or implant and the wound surface can be stationary or the instrument or implant can be moved across the wound surface. The contact between the instrument or implant and the wound surface is preferably a direct contact. For this contact the treatment instrument or implant comprises contact surfaces, which are advantageously equipped with energy directors. Such energy directors are elements projecting out of the contact surface in the form of e.g. cones, pyramids, ribs or edges. They serve for concentrating the energy to be coupled into the wound surface to points or lines and thus multiplying it. The energy directors project from the contact surface by 50 μm to 2 mm and are adapted to the way in which the instrument or the implant is moved during the operation in relation to the wound surface. The mechanical oscillations thus coupled with the tissue by the individual energy directors should be able to scan the entire wound surface. It is evident that the effect of the coupled sound according to the invention achieves a depth or expansion of 3 to 5 mm in bone tissue. This value naturally depends on operating time and power density (effective amplitude×frequency), and depending on the tissue is limited by the regeneration capacity of the locally produced trauma. Consequently the distance between the energy directors for an instrument or implant applied stationary to the wound surface during treatment should not exceed 6 to 10 mm and is preferably 2 to 5 mm. The same applies to the energy directors on implants or operation instruments which are moved only in one direction in relation to the wound surface (implanting direction), e.g. ridged or edged energy directors extending parallel in implanting direction. The distance between these energy directors should not exceed 6 to 10 mm providing the implant surface between them extends smoothly and does not considerably contribute to the energy input.

An implant used for carrying out the method according to the invention is positioned advantageously already under the influence of the oscillation in a tissue opening, or it is driven into the tissue with just a partial or no opening, wherein the implant is dimensioned such that with this positioning, the energy directors of the contact surface dislocate or compact the tissue in a furrowing manner, and thus create an intensive contact between the wound surface and the energy directors.

In cases where such a direct contact is not possible due to reasons of space for example, the oscillation of the instrument or of the implant is coupled into the wound surface to be treated via a coupling medium, which may be liquid, gel-like or solid (e.g. a film). The coupling medium conducts the oscillation (e.g. ultrasound) to be coupled into the wound surface well, i.e. it absorbs as little as possible oscillation energy and transmits the oscillation to the tissue to be treated with as little loss as possible. With the aid of the coupling medium which is not removed from the wound surface neither during nor after treatment, it is possible to also achieve a chemical-therapeutic effect on the wound surface to be treated or on tissue regions lying below the wound surface. For achieving such an effect, substances such as inflammation inhibitors, growth factors, zytostatic agents, radiation means, photosensitizers etc. are added to the coupling medium. Such substances may also be introduced into the tissue bordering the wound surface in a targeted manner by way of the oscillation. Physiological salt solution which is absorbed by the tissue after the treatment is an example of a suitable coupling medium.

Implants which are suitable for treating wound surfaces surrounding the implant according to the invention may have the most varied of implant functions. They are for example implants having a mechanical function (support or holding function) and/or a release function (e.g. the release of therapeutically effective substances or particle radiation or non-particle radiation) or they are space holders for missing tissue parts which, as the case may be, only have a temporary function and therefore consist at least partly of resorbable material or material able to be integrated into regeneration tissue.

If an implant is set into oscillation for the treatment of a wound surface this means that the treatment is carried out during and/or after positioning the implant and that the traumatic or necrotic effect achieved by way of the treatment in particular also acts on the undesired cells (e.g. connective tissue cells, mucous cells, tumour cells) which have been brought onto the wound surface with the implant, so that these calls can no longer inhibit the intergrowth between the tissue and the implant.

For an implant to be able to act as an oscillation body, i.e. as a body transmitting oscillation with minimal loss, and therefore to effect the above-described treatment of the wound surfaces surrounding it, the implant consists of a material having a modulus of elasticity of at least 0.5 GPa and is not substantially deformed by the oscillation (not even in the region of the energy directors when these are in contact with the wound surface). I.e. the implant material does not plasticize or liquefy even where it touches the wound surface, as is a prerequisite for the method according to the publication WO-02/069817 for creating connections with the tissue. Metallic implants of e.g. titanium or implants of a ceramic material fulfil this condition without any problem. For exciting the implant e.g. a sonotrode of an ultrasonic apparatus is pressed against a coupling surface provided on the implant, or the implant is rigidly but releasably fastened to such a sonotrode. A coupling element may be inserted between sonotrode and implant. The same conditions of course apply also to instruments which are to be used for carrying out the method according to the invention.

Experiments show that treatment of wound surfaces with oscillation energy coupled into the wound surfaces according to the invention achieve good results when using frequencies of 1 to 200 kHz, oscillation amplitudes in the region of 1 to 400 μm and energies in the region of 0.2 to 20 W per square millimetre of active surface. These good results can be recognised in histological sections as increased densities of vital cells and as signs of high biochemical activity in the region of the treated wound surfaces, which both favour a rapid and problem-free regeneration of tissue, e.g. in the form of intergrowth or healing. The energy used for the treatment is controllable via the frequency and amplitude of the applied oscillation, via the transmission of this oscillation to the instrument or implant and in particular also via the treatment time. The treatment may be carried out in a single treatment period or in a plurality of shorter treatment periods separated from one another by pauses, wherein the effective treatment time is a few seconds at the most.

As indicated further above, the effect of the oscillation energy coupled into the wound surface is a mechanical and a thermal one. The relative share of both effects is dependent on oscillation damping in the tissue (higher damping results in a higher thermal component, less damping results in a more mechanical effect). In a relatively hard tissue such as bone tissue thus the mechanical effect is not negligible, which in such a tissue may also lead to tissue compacting or displacement as already discussed further above.

The method according to the invention as well as exemplary embodiments of the device and of treatment instruments and implants for carrying out the method are described in detail in combination with the following figures, wherein:

### BRIEF DESCRIPTION OF THE DRAWINGS

FIG. 1 shows the treatment of a wound surface in a wound created by surgery, by injury or by disease, using an oscillating treatment instrument which is coupled to an ultrasonic hand device;

FIG. 2 shows the treatment of a wound surface which is created by the positioning of a screw-shaped self-cutting implant;

FIGS. 3 to 8 show exemplary embodiments of treatment instruments or implants according to the invention, which instruments and implants comprise contact surfaces equipped with energy directors;

FIG. 9 shows an embodiment of an element for amplitude and/or direction transformation, which element is applicable in a treatment device according to the invention;

FIGS. 10 and 11 show further embodiments of instruments for carrying out the method according to the invention.

### DETAILED DESCRIPTION OF THE PREFERRED EMBODIMENT

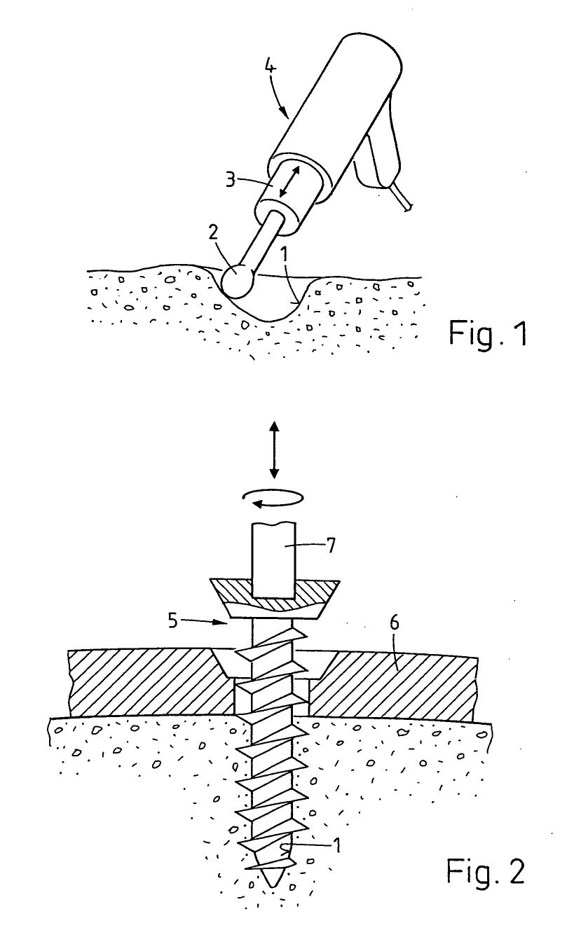

FIG. 1 shows the treatment of a wound surface 1 of a tissue wound created by surgery, injury or disease, for example a wound in a bone created by removal of a tumour. The treatment essentially comprises contacting the wound surface 1 to be treated with a treatment instrument 2, wherein the instrument 2 is formed as an oscillation body and is connected to an oscillation drive directly or via one or more further oscillation bodies 3 (booster, transmission element) which transform the oscillation direction and/or amplitude. The oscillation drive and the further oscillation bodies for example are components of a hand device 4, for example a hand-guided ultrasonic device. The oscillation drive for example comprises a stack of piezoelements which are set into mechanical oscillation by an electrical drive frequency. The oscillation drive and the treatment instrument 2 and, where appropriate, a further oscillation body or further oscillation bodies (booster, transmission element etc.) are designed such that they oscillate in resonance at the excitation frequency of the oscillation drive.

Applicable ultrasonic apparatus are for example known from dental medicine where they are used for removing tartar, or from the initially mentioned publication U.S. Pat. No. 6,139,320 (Hahn).

The instrument 2 may also be driven in oscillation via a relatively long and thin transmission element which is capable of oscillation and is possibly flexible, thus rendering the arrangement suitable for minimal-invasive surgery.

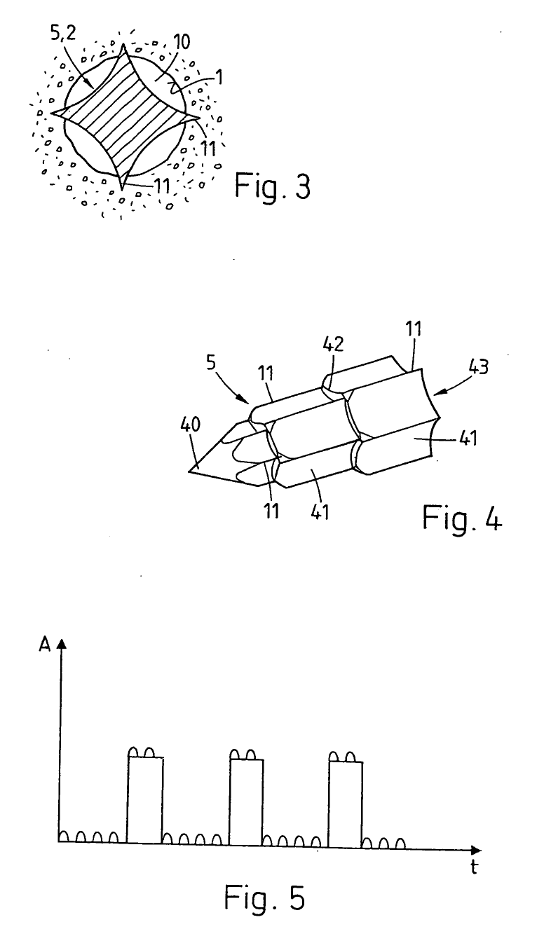

FIG. 2 shows the treatment of a wound surface 1, which is created by positioning a self-cutting implant 5 and surrounds the implant. The implant 5 is for example, as shown, a self-cutting screw being driven into a bone for fastening a plate 6. The screw is driven into the bone tissue by rotation and after this driving-in or already during the driving-in ultrasound is applied to it. The oscillations are coupled into the bone tissue particularly in the region of the thread acting as energy directors. According to the aforementioned model the threads are therefore to be set apart by no more than 6 to 10 mm provided the surface in between is free of differently designed energy directors.

To drive in the implant shown in FIG. 2, e.g. an appropriately shaped sonotrode 7 of an ultrasonic apparatus is placed onto the head of the screw and is pressed against it. The sonotrode may also serve for rotating the screw, wherein through the oscillation torque or friction to be overcome respectively, is significantly reduced. For being able to rotate the screw, the sonotrode is arranged rotating on a hand apparatus and, as shown in FIG. 2, is designed for being placed on or fastened to the screw head in a rotationally secure manner (e.g. square). Of course, it is possible also to drive the screw in using a known tool and only then applying the ultrasound.

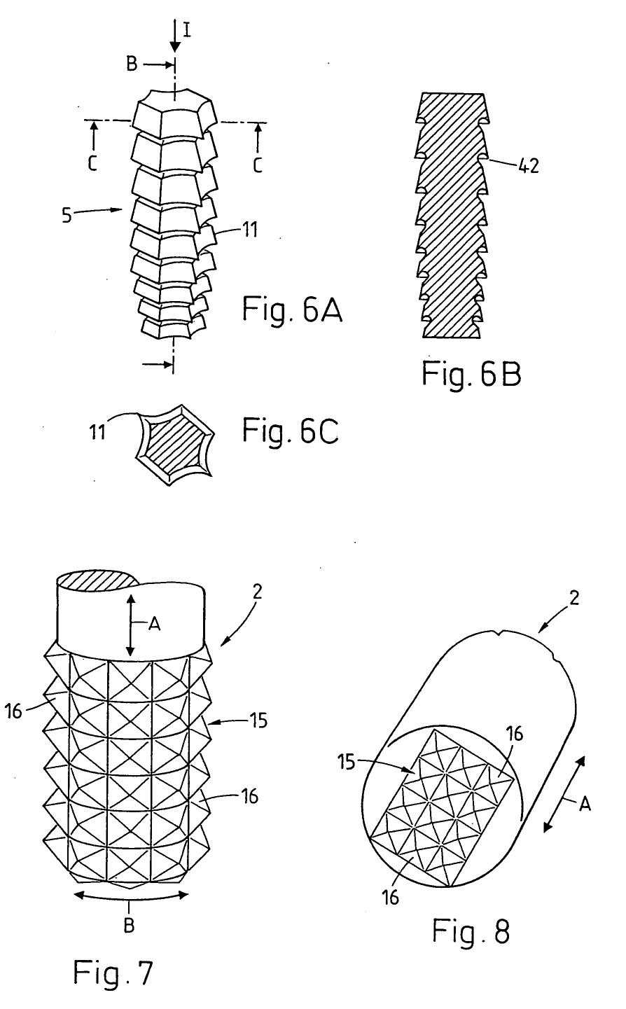

FIGS. 3 to 8 show exemplary embodiments of the distal ends of treatment instruments or implants for carrying out the method according to the invention, which at the contact surfaces comprise various energy directors. The distal end of a treatment instrument does not in principal differ from the distal end of an implant since they are designed for carrying out the same method. The proximal end of treatment instruments advantageously comprises means for a releasable coupling to a device comprising an oscillation drive, but may also be fixedly coupled to such a device. The proximal end of implants may likewise comprise means for a releasable coupling to a device comprising an oscillation drive. The proximal implant end may also simply comprise a coupling surface being suitable for oscillation coupling by pressing an oscillating body against it.

FIG. 3 shows a cross section of an implant 5 according to the invention (e.g. dental implant) which implant is positioned in a tissue opening 10. The implant comprises axially running edges 11 by way of which the wound surface 1 to be treated (inner surface of the tissue opening 10) are slightly furrowed and which in this manner serve as energy directors. The implant is impinged with e.g. ultrasound during and/or after its positioning in the tissue opening 10. For this purpose it is fastened on a sonotrode or it is pressed into the tissue opening by way of the sonotrode. FIG. 3 may also be understood as a cross section through the distal end of a treatment instrument 2. As the implant or instrument, due to Its furrowing action, can only be moved axially in the tissue opening, the distance between the edges 11 must not exceed 6 to 10 mm, in particular when the furrowing concerns only a small part of the wound surface as illustrated in FIG. 3.

FIG. 4 shows a further implant 5 (where appropriate also the distal end of a treatment instrument) which is particularly suitable for carrying out the method according to the invention if it is positioned in a conical or stepped tissue opening. The implant 5 has a distal tip 40 and a plurality of essentially cylindrical (where appropriate slightly conical) regions 41, wherein the diameters of the cylindrical regions 41 increase away from the tip 40 and wherein the tip 40 and cylindrical regions 41 comprise axially running, projecting edges 11 which furrow the inner surface of the tissue opening (wound surface) provided for the implant. Depending on the density of the bone the extent of the pre-existing or prepared tissue opening can be adjusted to the requirements. In the case of spongious or osteoporal bone it may be possible to drive the implant into the bone tissue without an opening, wherein the implant advances by compressing the bone. The steps between the cylindrical regions 41 are also shaped as furrowing edges 42.

The proximal end face 43 of the implant 5 is designed as a coupling surface for co-operation for example with a sonotrode, i.e. it is designed such that a sonotrode for example may be held against it and the oscillation of the sonotrode is transmitted to the implant. This proximal end face 43 is for example a planar surface being as smooth as possible.

FIG. 5 shows very schematically a diagram of amplitude versus time t for oscillation as it is advantageously coupled into an implant as shown in FIGS. 3 and 4. Coupling achieved by merely positioning an oscillating part onto the implant can transmit only oscillation parts in one direction (pushing only, no pulling, so-called semioscillation). This generates an amplitude only on one side of the abscissae (semi-aplitutudes, here the positive side). It proves to be advantageous to superimpose an oscillation of relatively high frequency (e.g. ultrasonic sound) and small amplitude (1 to 100 μm) with an oscillation of low frequency (several tens to several hundred hertz) and a considerably higher amplitude (several hundred μm). The stronger ‘pulses’ are used in particular to drive in the implant and the high frequency oscillation for the treatment of the wound surface. Similar effects can be produced if e.g. increased acceleration and therefore higher impulses are generated by at least occasionally changing the wave mode (e.g. saw tooth instead of sine wave).

FIGS. 6A to 6C show a further exemplary implant 5 comprising, as the implant of FIG. 4, furrowing edges which extend axially on one hand and around the implant's periphery on the other. The implant is shown three-dimensionally in FIG. 6A, as an axial section in FIG. 6B, and as a cross-section in FIG. 6C. The implant 5 may be e.g. a dental implant being implanted into a conical opening of a jaw bone, wherein the axially extending edges 11 furrow the inner surface of the opening essentially during the entire implantation motion (implant direction: arrow 1) and the edges 42 extending along the implant's periphery at least during a last phase while touching the inner surface. To enable the edges extending around the implant to contribute to the implant's stability, they are advantageously designed facing the distal end of the implant, slightly protruding and being undercut, as apparent from FIG. 6B. It may also be advantageous to allow the edges running around the implant a certain clearance angle, as illustrated, in order to e.g. further concentrate the energy input. It is not a condition therein that the edges 42 extend at a constant axial height or all around the implant. Likewise it is not a condition that the axial edges extend continuously or in the same number or same geometry over the whole axial length of the implant.

FIGS. 7 and 8 show distal ends of treatment instruments 2 (or where appropriate implants) which have a contact surface 15 with a pattern of energy directors 16 (e.g. pyramids protruding from the contact surface). The instrument 2 represented in FIG. 7 may be designed for axial oscillation (double arrow A) or for bending oscillation (double arrow B). The instrument shown in FIG. 8 is advantageously designed for axial oscillation. The gaps between the points of the energy directors need to be adjusted to a relative movement between instrument and wound surface in such a manner that every region of the wound surface to be treated is positioned at least once in an area not more than 3 to 5 mm distanced from such a point, preferably within 1 to 2.5 mm from such a point. If the instrument is not to be moved relative to the wound surface, the points need to be arranged no further apart than 6 to 10 mm (preferably at a distance of between 2 to 5 mm from each other).

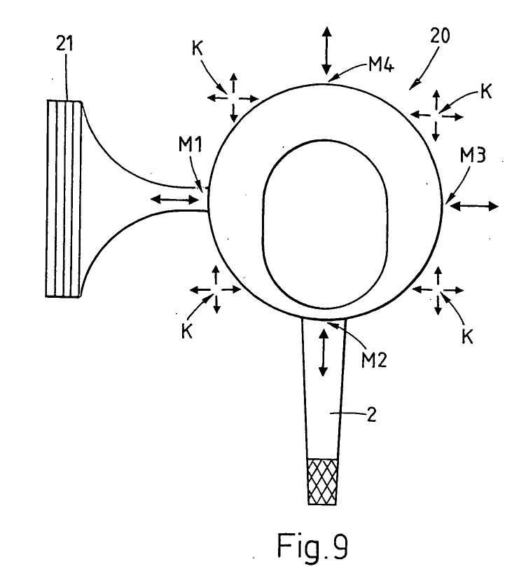

FIG. 9 shows an amplitude-transforming and/or direction-transforming element 20 which was already discussed further above and which is incorporated in a device according to the invention, advantageously between the treatment instrument 2 or as the case may be the implant, and the oscillation drive 21 or a booster. However, element 20 may also serve itself as treatment instrument.

The element 20 for example is annular. It is designed in a manner such that with a predefined excitation frequency it oscillates in resonance and specifically in the radial direction with four nodes K (points of minimal oscillation amplitude and two-dimensional oscillation) and four points M1 to M4 of maximal oscillation amplitudes (one-dimensional oscillation). In axial direction the ring is dimensioned such that oscillation with an axial amplitude remains negligible. By designing the ring with a varying radial thickness, or with local recesses in the ring (locally varying mass), or with corresponding local stiffening, various amplitudes can be achieved at the points M1 to M4. The amplitude is smaller at such points of high mass or great stiffness than at points of smaller mass or smaller stiffness.

For the element 20 represented in FIG. 9 the points M1, M3 and M4 have greater local masses than point M2, which thus oscillates with a greater amplitude (illustrated by the longer double arrow). If further elements (e.g. treatment instrument 2) are coupled at points M1 to M4, their effect with respect to local ring mass and ring stiffness is to be taken into account, or is to be compensated accordingly at the other points.

The oscillation drive 21 (where appropriate via a booster) is advantageously coupled to the ring at a point of maximal oscillation amplitude (M1 to M4), transmitting the drive amplitude to this location. Depending on the application and depending on the design of the oscillation drive 21, a treatment instrument 2 for a high amplitude and one-dimensional oscillation is coupled to a point M, or for a small amplitude and two-dimensional oscillation to a point K.

According to FIG. 9 the instrument 2 is coupled to point M2 (lowest local ring mass or lowest ring stiffness, thus largest amplitude), and the oscillation drive 21 to point M1 so that the ring functions as an amplitude amplifier and as a direction transformer (90°). If the oscillation drive 21 is coupled to point M4 the element 20 acts as an amplitude amplifier only.

An amplitude-transforming and/or direction-transforming element 20 according to FIG. 9 for an excitation frequency of approx. 20 kHz for example is a ring of steel with a diameter of approx. 8mm to which instruments of approx. 0.5 g weight may be coupled. For the instrument to be able to function as a resonator it should have a length which corresponds to half the wavelength (for steel and 20 kHz: approx 14 mm) or a multiple of this.

Instead of the instrument 2 being coupled (e.g. moulded) to element 20 as shown in FIG. 9, a corresponding extension (not illustrated) may be provided in this place, which extension is placed on the proximal face of an implant for simultaneously driving the implant into the tissue opening and exciting it to vibrate.

Amplitude-transforming and/or direction-transforming elements applicable in the method according to the invention are generally geometric bodies such as beams, rings or hollow balls. Annular elements may also have shapes which are not circularly round, but are e.g. polygonal. The rings may also be designed for oscillation for example with three, five or more nodes, that is to say for direction transformation with angles other than 90°. For direction-transformations in three-dimensional space, element 20 is designed as a hollow body, for example a hollow ball or a hollow polyhedron. The rings as well as the hollow bodies may have a plurality of coupling locations for an instrument 2 or where appropriate for an implant as well as for the oscillation drive 21.

As the case may be it is not necessary to couple a treatment instrument 2 to the element 20 but to apply the element 20 itself for the treatment, wherein in such a case it is advantageous to provide the outer surface of the element 20 with energy directors.

Since the design of the instrument 2 as well as the characteristics of its oscillation are to be adapted to specific applications, it is advantageous to design the instrument 2 and the amplitude-transforming and/or direction-transforming element 20 as a unit and for different direction transformations for example to provide it with various coupling locations for coupling to a standard oscillation drive 21 being e.g. integrated in a hand apparatus.

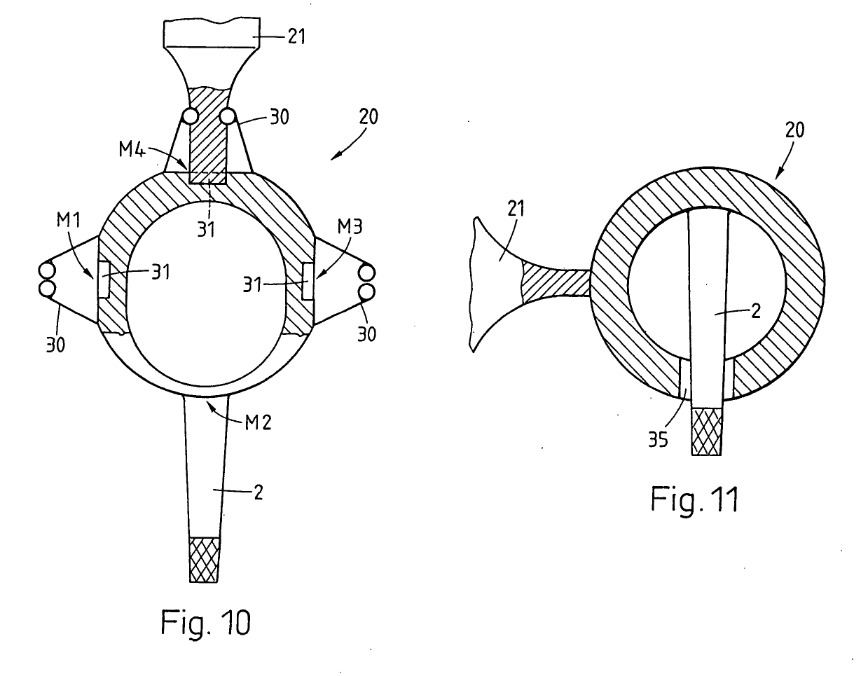

Such a unit of an amplitude-transforming and/or direction-transforming element 20 and an instrument 2 is shown in FIG. 10. The treatment element 2 is coupled to point M2 of the amplitude-transforming and/or direction-transforming element 20. At points M1, M3 and M4 coupling elements 30 are provided, for example snap elements by way of which a booster element of the oscillation drive 21 is pulled into a seat 31 of the element 20 with a non-positive fit. The larger the snap force is, the closer to the exciting wave will the transferred wave be.

For minimal-invasive methods it is advantageous to provide means which permit changing the coupling between element 20 and the oscillation drive 21 (which may also be designed to be flexible and to have a length of a multiple of half the wavelength for endoscopic use) when the distal end of the device is already positioned for treatment, i.e. when it is located in the treatment region. The element 20 is for example coupled to the drive at point M4 (no frequency transformation and smallest dimension of the device transverse to the introduction direction) for the introduction to the treatment region, and at point M1 or M3 (direction transformation in each case 90°) for the treatment or for part of the treatment.

Instead of coupling the instrument 2 to the outer side of the element 20 as shown in FIGS. 9 and 10 the instrument 2 may also be coupled on the inner side of the element and on the opposite side may project through a suitable opening 35, as this is shown in FIG. 11. This is particularly advantageous if for reasons of space (e.g. a device for a minimal-invasive method) the instrument is to project as little as possible beyond the element 20 and all the same it needs to have a predefined length for resonance reasons.

Treatment instruments 2 which in each case are rigidly connected to an amplitude-transforming and/or direction-transforming element 20 exactly matched to the instrument make it possible to achieve optimal treatment conditions for the most varied of applications using only one apparatus supplying essentially one excitation frequency or a small number of selectable excitation frequencies. Such treatment instruments may not only be used in the method according to the invention but also in other methods in which vibrating treatment instruments are applied, in particular in various, per se known methods of dental medicine.

1. A method for promoting tissue regeneration on wound surfaces (1), in particular on wound surfaces which are to intergrow with other wound surfaces or with an implant, or are to heal into a tissue surface, wherein mechanical oscillation is coupled into the wound surface (1) with the help of a treatment instrument (2) or an implant (5).

2. The method according to claim 1, wherein the mechanical oscillation is ultrasonic oscillation having a frequency of 1 to 200 kHz.

3. The method according to claim 1, wherein a contact surface of the treatment instrument (2) is brought into contact with the wound surface (1) and mechanical oscillation is applied to the treatment instrument, wherein the treatment instrument (2) is moved or is stationery in relation to the wound surface during treatment.

4. The method according to claim 1, wherein, a contact surface of the implant (5) is brought into contact with the wound surface (1) and mechanical oscillation is allied to the implant (5) during an implanting movement relative to the wound surface (1) and/or after the implanting movement when the implant is in its implanted condition.

5. The method according to claim 4, wherein the implant (5) comprises self-cutting or furrowing structures and wherein the implant is positioned in the tissue with the help of mechanical oscillation.

6. The method according to claim 4, wherein the implant (5) is positioned in an opening of the tissue and is then set into oscillation.

7. The method according to claim 3, wherein the contact between the treating surface of the treatment instrument (2) or of the implant (5) and the wound surface (1) to be treated is a direct contact.

8. The method according to claim 3, wherein a liquid, gel-like or solid coupling medium is applied between the treatment instrument (2) or the implant (5) and the wound surface (1) to be treated.

9. The method according to claim 8, wherein chemo-therapeutically effective substances are added to the coupling medium.

10. The method according to claim 1, wherein the wound surface (1) is a bone tissue surface.

11. The method according to claim 4, wherein the implant (5) is a dental implant which is positioned in an opening of a jawbone.

12. A device for promoting tissue regeneration on wound surfaces (1), in particular on wound surfaces which are to intergrow with other wound surfaces or with an implant, or are to heal into a tissue surface, wherein mechanical oscillation is coupled into the wound surface, wherein the device comprises an oscillation drive and a treatment instrument (2) that is designed for being oscillated by the oscillation drive, or coupling means for coupling such a treatment instrument (2) or implant (5) to the device.

13. The device according to claim 12, wherein the means for coupling an implant (5) is a smooth coupling surface which is positionable on a proximal surface of the implant (5).

14. The device according to claim 12, further comprising an amplitude-transforming and/or direction-transforming element (20), wherein the treatment instrument or the coupling means are arranged on said element.

15. The device according to claim 14, wherein the amplitude-transforming and/or direction-transforming element (20) comprises a plurality of coupling locations in which said element can selectively be coupled to the oscillation drive.

16. The device according to claim 14, wherein the amplitude-transforming and/or direction-transforming element (20) has the shape of one of a beam, a ring and a hollow body.

17. The device according to claim 16, wherein the treatment instrument (2) is fastened to an outside surface of the amplitude-transforming and/or direction-transforming element (20).

18. The device according to claim 16, wherein the amplitude-transforming and/or direction-transforming element (20) is annular or has the shape of hollow-body and that the treatment instrument (2) is fastened to an inner surface of the amplitude-transforming and/or direction-transforming element (20) and projects from the element (20) through an opposite opening (35).

19. A treatment instrument (2) or implant (5) for carrying out the method according to claim 1, wherein the instrument or implant is designed as an oscillation body, a proximal end of said instrument or implant comprises means for a fixed or releasable coupling or is connected or integrally formed to an amplitude-transforming and/or direction-transforming element (20) or comprises a proximal contact surface designed for oscillation coupling, and wherein the instrument or implant comprises in the region of a distal end contact surfaces (15) for contacting the wound surface, said contact surfaces being provided with energy directors (16).

20. The treatment instrument or implant according to claim 19, wherein the energy directors (16) have the shape of tips or edges projecting from the contact surface (15).

21. The treatment instrument or implant according to claim 19, wherein the energy directors (16) protrude from the contact surface by at least 50 μm.

22. The treatment instrument or implant according to claim 19, wherein the energy directors (16) are no further apart than 6 to 10 mm.

23. The treatment instrument or implant according to claim 20, wherein the energy directors (16) have the shape of edges (11) running in a spiral or axial manner and designed to furrow the wound surface on positioning the instrument or implant.

24. The treatment instrument or implant according to claim 23, further comprising a distal tip (40) and joined on the tip (40), a plurality of essentially cylindrical or conical regions (41) with diameters getting larger with an increasing distance to the tip (40), wherein the tip (40) and the cylindrical or conical regions (41) are provided with axially running, furrowing edges (11), and wherein steps between the cylindrical or conical regions (41) are likewise configured as furrowing edges (42).

25. The treatment instrument or implant according to claim 23, wherein the instrument or implant is essentially conic and at least partially comprises axially extending edges and edges extending around at least a part of an instrument or implant circumference.

26. The treatment instrument or implant according to claim 25, wherein the edges extending around at least a part of the instrument or implant circumference are at least partially undercut.

27. The treatment instrument or implant according to claim 25, wherein the edges extending around at least a part of the instrument or implant circumference comprise at least partially a clearance angle.
